(19) United States
(12) Patent Application Publication
(10) Pub. No.: US 2003/0234574 A1
(43) Pub. Date: Dec. 25, 2003

(54) Electro-hydraulic control unit with integral precharge pump for a controlled braking apparatus

(75) Inventors: David F. Reuter, Beavercreek, OH (US); Earl Wayne Lloyd, Lebanon, OH (US); Timothy A. Haerr, Enon, OH (US); Jamshid Moradmand, Dayton, OH (US)

Correspondence Address: SCOTT A. MCBAIN, DELPHI TECHNOLOGIES, INC., Legal Staff, Mail Code 480-410-202, P.O. BOX 5052, Troy, MI, 48007, US

(73) Assignee: DELPHI TECHNOLOGIES INC.

(21) Appl. No.: 10/453,131

(22) Filed: Jun. 3, 2003

Related U.S. Application Data
(60) Provisional application No. 60/389,973, filed on Jun. 19, 2002.

(51) Int. Cl. B60T 8/40

(52) U.S. Cl. 303/116.2

(57) ABSTRACT

An electro-hydraulic control unit for a controlled braking system includes a hydraulic control unit (HCU) having a controlled braking pump and a pre-charge pump driven by a single motor. The HCU also includes one or more hydraulic components for controlling a flow of hydraulic fluid in the braking apparatus.

This application claims the benefit of commonly assigned: U.S. Provisional patent application bearing the serial No. 60/389,973 titled ELECTRO-HYDRAULIC CONTROL UNIT WITH INTEGRAL PRE-CHARGE PUMP, by Reuter, et al; and U.S. Provisional patent application bearing the serial No. 60/439,935, titled CONTROLLED BRAKE SYSTEMS FOR VEHICLES, by Reuter, et al.

### TECHNICAL FIELD OF THE INVENTION

This invention relates to vehicle brakes, and more particularly to a vehicle with a brake apparatus including both a controlled braking pump for providing brake fluid during controlled braking operation of the vehicle, and a pre-charge pump for augmenting fluid flow to the inlet of the controlled braking pump.

### BACKGROUND OF THE INVENTION

Since the mid 1930s, vehicles such as automobiles and light trucks have predominantly utilized hydraulic brake systems having a pedal operated master cylinder supplying pressurized hydraulic fluid to disk or drum braking devices at each wheel.

Early hydraulic brake systems utilized a single hydraulic fluid circuit supplying pressurized fluid from the master cylinder to all four comers of the vehicle. A break in the fluid circuit anywhere rendered the entire hydraulic brake system inoperative.

In order to prevent a total loss of hydraulic braking in the event of a failure of part of the system, failsafe hydraulic split brake systems were developed that provided two separate fluid circuits from the master cylinder, configured such that a failure of either of the two fluid circuits would still leave hydraulic brakes operative on at least two corners of the vehicle. In rear wheel drive automobiles and light trucks, one fluid circuit typically served the front wheels, and the other fluid circuit served the rear wheels, to provide a front/rear (F/R) failsafe hydraulic split system. Front wheel drive vehicles typically used a diagonal failsafe hydraulic split system, having one front comer and the diagonally opposite rear comer of the vehicle on one fluid circuit, and the other front corner and its diagonally opposite rear comer on the second fluid circuit. Government stopping distance regulations were passed in regards to failed brake system performance that, in order to comply, required brake systems to be configured such that a single failure of the braking system would still leave the brakes on at least two corners of the vehicle operational.

In the years since hydraulic brake systems became the norm, many additional features have been added to further enhance safe operation and optimize vehicle performance. Modem brake systems often include a booster that amplifies force exerted on the brake pedal, to provide power brakes that allow a person operating the vehicle to control the brakes with significantly less force on the brake pedal than is required in a non-boosted brake system. Anti-lock brake systems (ABS) were developed in which valves controlling fluid flow to each comer of the vehicle were pulsed, in response to signals received from rotation sensors monitoring each wheel, to preclude locking the brakes on slippery road surfaces. Traction control systems (TCS) were added that controlled both the brakes and the engine throttle setting to improve traction and handling of the vehicle during maneuvers, such as acceleration or turning, when the brakes are not being applied by the operator. Vehicle dynamics control (VDC) further advanced the level of sophistication of brake systems to utilize a number of sensors throughout the vehicle, and a more advanced onboard computer with higher throughput, to monitor forces acting on the vehicle, together with inputs indicating operational commands from the operator applied to the steering, braking, and drive systems. VDC analyzes the data received from the sensors and coordinates operation of the various elements of the vehicle brake system, power-train, and suspension to provide enhanced vehicle safety or performance of the vehicle.

The addition of all of these enhancements has made hydraulic brake systems very complex. Numerous valves, sensors, and electronic control components are required. Brake systems offering one or more types of automated control operating modes, such as ABS, TCS and VDC, are known as “controlled braking systems.”

Recent advances in technology have made it feasible to develop a controlled brake system that utilizes electrically actuated brakes, rather than hydraulic brakes, on at least the rear corners of a vehicle. Such brake systems are known as “Hybrid” brake systems. Commonly assigned U.S. patent application Ser. No. 10/121,454, titled Hybrid. Brake System for a Vehicle, by Reuter, et al, describes such a system, and is incorporated herein by reference.

To provide a flow of pressurized brake fluid during controlled braking operation in modes such as TCS and VDC where there is no brake pressure being produced by the master cylinder because the brake pedal is not depressed, controlled braking systems typically include a controlled braking pump driven by an electric motor for recirculating pressurized brake fluid through the controlled braking circuit during one or more of the controlled braking operations. Such controlled braking pumps must also be capable of starting and producing braking pressure m a fraction of a second when the braking system recognizes the need for and initiates a controlled braking operation.

A controlled braking pump must further be an efficient suction-type pump, since fluid must be drawn from the remote master cylinder reservoir and subsequently pumped through extended brake lines to the wheel brake. At low ambient operating temperatures, the brake fluid becomes more viscous and flows through the fluid passages in the brake circuit at a significantly slower rate, making it difficult to get the controlled braking pump primed quickly enough to provide adequate braking pressure during a controlled braking event, such as VDC during a quick swerving maneuver, for example.

Prior controlled braking systems ‘A’, such as the one shown in FIG. 1, have incorporated a pre-charge circuit connected in parallel with the master cylinder, and in series with the hydraulic brake circuit to provide a pressurized flow of brake fluid through the hydraulic brake circuit lines to the inlet of the controlled braking pump under cold ambient operating conditions.

The prior controlled braking system A shown in FIG. 1 includes a master cylinder 12, as shown in FIG. 2, having a cylinder bore 14, a fluid reservoir 16 for brake fluid, a bleed port 18 providing fluid communication between the cylinder bore 14 and the fluid reservoir 16, and a primary piston 20 movable in the bore 14 for closing off the bleed port 18 and generating hydraulic braking pressure in the bore 14.

A primary hydraulic brake circuit 22, indicated by dashed lines in FIG. 1, is connected in a series fluid circuit relationship to the bore 14 of the master cylinder 12 for delivering pressurized brake fluid at the braking pressure to an inlet/outlet 24 of a hydraulically actuated braking device 26 and receiving a return flow of brake fluid from an inlet/outlet 24 of the hydraulically actuated braking device 26. It will be noted that the brake system A shown in FIG. 1 includes a primary hydraulic braking circuit 22 having a number of components for controlling the flow and pressure of brake fluid to both a left and right front braking device LF, RF, and a secondary braking circuit, generally indicated by arrow 28, for controlling both a left and right rear braking device LR, RR.

Because the components in the primary and secondary braking circuits 22, 28 are generally identical, only the components in the primary circuit 22 will be described in detail below. It will also be noted that in the system A shown in FIG. 1 the inlet and outlet to the braking device 26 is indicated by a single line 24. It should be noted that, although FIG. 1 shows a front/rear split hydraulic system, the same basic circuit arrangement may also be utilized for a diagonal split hydraulic system where, for example, the RF and LR braking devices are connected to the master cylinder primary hydraulic outlet circuit 66 and the LF and RR braking devices are connected to the secondary master cylinder hydraulic outlet circuit 28.

The primary hydraulic brake circuit 22 includes a normally open inlet control valve 30 and a normally closed outlet control valve 32 for controlling flow in and out of each of the LF and RF braking devices 26. Each of the control valves 30, 32 also has associated therewith a check valve 34 allowing reverse flow, in a direction toward master cylinder 12, through the check valve 34 when its associated control valve 30, 32 is in the closed position. The primary brake circuit also includes an isolation valve 36 and an associated check valve 38, allowing flow through the check valve 38 in a forward direction, toward the braking device 26, when the isolation valve 36 is in the closed position. The isolation valve 36 is utilized for regulating or closing off the flow of brake fluid through a portion of the hydraulic brake circuit 22 from the master cylinder 12 during certain controlled braking operations.

A controlled braking pump 40 has an inlet 42 operatively connected through a check valve 46 for receiving brake fluid from the primary hydraulic brake circuit 22. An accumulator 48 is also connected to both the primary brake circuit and the check valve 46 for storing brake fluid received from the primary brake circuit 22, and delivering the stored brake fluid through the check valve 46 to the inlet 42 of the controlled braking pump 40. The controlled braking pump 40 also includes an outlet 44 operatively connected through a damper 50 and an orifice 52 for providing pressurized brake fluid to the hydraulic brake circuit 22 at the braking pressure. The controlled braking pump 40 is driven by a motor 54.

From the description above, it will be evident that controlled braking systems include a substantial number of components, connected by a number of complex shaped hydraulic conduits or internal passages within the components. At cold operating temperatures, the brake fluid becomes thick and viscous, and it can be difficult for the controlled braking pump 40 to generate enough suction at its inlet to quickly generate an adequate flow of fluid for controlled braking operation. To address this problem, some prior controlled braking systems have included a pre-charge circuit, including a pre-charge pump, to help supply an adequate flow of fluid to the inlet of the controlled braking pump 40 at all operating temperatures, for priming the controlled braking pump 40.

The prior controlled braking system A, shown in FIG. 1, incorporates a pre-charge circuit, generally indicated by arrow 56, including a pre-charge pump 58 having an inlet 60 operatively connected to the fluid reservoir 16, and an outlet 62 operatively connected via an outlet check valve 64 to an inlet portion 66 of the primary hydraulic circuit 22, with the inlet portion 66 being further connected to bore 14 of the master cylinder 12. The outlet check valve 64 is required, between pre-charge pump 58 and primary hydraulic brake circuit 22, to prevent reverse flow of fluid from the primary circuit 22 through the pre-charge pump 58 and pressure relief valve 76.

As will be seen from FIG. 2, the master cylinder 12 also includes a secondary piston 68 and a secondary bleed port 70 in the bore 14. The secondary piston 68 is separated axially from the primary piston 20 by a space, indicated by arrow 72, between the primary and secondary pistons 20, 68. The connections between the outlet 62 of the pre-charge pump 58 and the inlet portion 66 of the primary hydraulic brake circuit 22 are made to the bore 14 in the space 72 between the primary and secondary pistons 20, 68, such that pre-charge pressure generated by the pre-charge pump 58 will be communicated directly to the primary hydraulic brake circuit 22 via the inlet 66, and indirectly to the secondary hydraulic brake circuit 28 by movement of the secondary piston 68 in the bore caused by the existence of the pre-charge pressure in the space 72 between the primary and secondary pistons 20, 68 generating an axially acting force on the secondary piston 68. Some of the flow from the pre-charge pump 58 is lost though primary bleed orifice 18, but the pre-charge pump 58 is adequately sized to allow for this loss.

The pre-charge circuit 56 further includes a second motor 74 driving the pre-charge pump 58, and a pressure relief valve 76 connected between the inlet to the outlet 60, 62 of the pre-charge pump 58 for regulating the pre-charge pressure generated by the pre-charge pump 58.

The pre-charge circuit 56 also includes a prime valve 78, having an inlet 80 connected to the input 66 of the primary hydraulic brake circuit 22, and an outlet 82 connected to the inlet 42 of the controlled braking pump 40, for selectively blocking and allowing a flow of brake fluid through the prime valve 78 between the inlet 66 of the primary hydraulic circuit 22 and the inlet 42 of the controlled braking pump 40. A check valve 84 allows reverse flow of brake fluid through the check valve 84 when the prime valve 78 is blocking flow.

The brake apparatus A also includes a control circuit 86 including a number of sensors, and a control unit (ECU) for sensing when the brake apparatus A should be operated in a controlled braking mode, and connections to the control elements of the apparatus for controlling these elements during the controlled braking operation.

Prior brake systems of the type described above have several drawbacks. Because the prime valve 78 and its associated check valve 84 are connected to the bore 14 and the inlet 66 to the primary hydraulic circuit 22, they must be designed to withstand and operate at typical braking pressures of about 2000 pounds per square inch. The need to withstand and operate at maximum braking pressures significantly increases the size, weight and cost of the prime valve 78.

As shown in FIG. 3, in the past it has been common practice to split the various components of a controlled braking system having a pre-charge circuit 56, such as the system A shown in FIG. 1, into two packages.

A first grouping of components, known as an electro-hydraulic control unit (EHCU) 200 includes a hydraulic control unit (HCU) 210 and an electronic control unit (ECU) 212 for controlling the HCU 210. The HCU 210 typically includes a block 214 containing the controlled braking pump 40 and other hydraulic components of the controlled braking system A required for operation of the controlled braking system A in its various operational modes. The motor 54 is attached to the block 214 of the HCU 210, for driving the controlled braking pump 40. The EHCU 200 is typically mounted to a body panel in the under-hood area of the vehicle, remotely from the master cylinder 12, fluid reservoir 16, and brake booster 216, wherever there is a sufficient space.

The second grouping of components includes the pre-charge pump 58, a second motor 74 for driving the pre-charge pump 58, and sometimes a second block including hydraulic components of the pre-charge circuit, such as the pressure relief valve 76, and check valve 64, as shown in FIG. 1. This second grouping of components including the pre-charge pump 58 and its associated motor 74 are typically mounted separately from the EHCU 200, preferably in close proximity to the fluid reservoir 16 of the master cylinder 12.

Mounting the pre-charge pump 58, its drive motor 74, and associated components of the pre-charge circuit remotely from the EHCU 200, as illustrated in FIG. 3 is undesirable for a number of reasons. Having the pre-charge pump 58, together with its associated drive motor 74 and hydraulic components, mounted separately from the EHCU 200 adds a large undesirable volume, on the order of about 500 cubic centimeters to the brake system A, as well as additional weight, complexity and cost. The additional volume consumes valuable space, in under-hood area of the vehicle, which could be more advantageously used for other purposes.

Commonly assigned United States utility patent application, Ser. No. 10/174,601, titled BRAKE SYSTEM FOR A VEHICLE HAVING AN INTEGRAL PRECHARGE PUMP, by Reuter, et al, filed on Jun. 19, 2002, and commonly assigned United States utility patent application, bearing Assignee's docket number DP-309725, titled BRAKE SYSTEM FOR A VEHICLE HAVING AN INTEGRAL PRECHARGE PUMP AND BACK-FLOW PROTECTION, by Reuter, et al, filed on ______, provide a controlled braking apparatus that resolves a number of the problems with prior controlled braking systems having pre-charge circuits, as described above.

Although controlled braking systems practicing the teachings of Reuter, et al, Ser. No. 10/174,601, and docket number DP-309725 provide considerable improvement over prior controlled braking systems, further improvement is desirable. In particular, it is desirable to provide hardware configurations that further reduce the under-hood volume, weight and component cost for providing a controlled braking system including a pre-charge circuit. It is also desired that the improved brake apparatus be applicable to hybrid as well as conventional totally hydraulic controlled brake systems, and that such an improved brake apparatus be applicable to a wide range of embodiments of controlled braking systems, including braking systems according to Reuter, et al, Ser. No. 10/174,601, and docket number DP-309725.

### SUMMARY OF THE INVENTION

Our invention provides an improved controlled brake apparatus, meeting the requirements discussed above through use of a hydraulic control unit (HCU) including a controlled braking pump and a pre-charge pump driven by a single motor. The HCU may also include one or more hydraulic components for controlling a flow of hydraulic fluid in the braking apparatus. Combining both the controlled braking pump and pre-charge pump into the HCU and driving them with the same motor considerably reduces under-hood volume of the controlled braking apparatus, in comparison to prior controlled braking systems having pre-charge pumps, where the pre-charge pump was driven by different motor than the controlled braking pump and the pre-charge pump and its drive motor were mounted remotely from the HCU. Our invention may also take the form of an electro-hydraulic control unit EHCU, having an electronic control unit ECU attached to the HCU.

Our invention is applicable to a variety of controlled braking systems including hydraulic, hybrid and electrically actuated braking devices including electro-mechanical and electro-hydraulic brake devices, and may also take the form of a method for operating a controlled braking apparatus including an HCU of the type described herein.

The foregoing and other features and advantages of our invention will become further apparent from the following detailed description of exemplary embodiments, read in conjunction with the accompanying drawings. The detailed description and drawings are merely illustrative of our invention rather than limiting, the scope of the invention being defined by the appended claims and equivalents thereof.

### BRIEF DESCRIPTION OF THE DRAWINGS

FIG. 1 is a schematic representation of a prior controlled brake system having a pre-charge pump mounted remotely from the controlled braking pump, and driven by a separate motor from the controlled braking pump;

FIG. 2 is a cross section of a typical master cylinder of the type used in the prior brake system of FIG. 1, and in exemplary embodiments of brake systems, according to our invention, as shown in FIGS. 3-10;

FIG. 3 is a perspective view of several components of the prior braking system of FIG. 1 showing the manner in which the components were mounted in two groups of components, with the controlled braking pump and a motor for driving the controlled braking pump mounted in an electro-hydraulic control unit (EHCU), and the re-charge pump together with its separate drive motor in a second grouping of components mounted remotely from the EHCU;

FIG. 4 is a perspective view of an EHCU according to our invention, including a controlled braking pump and a pre-charge pump driven by a single motor;

FIG. 5 is a schematic of a first exemplary embodiment of a controlled braking apparatus, according to our invention;

FIGS. 6 and 7 show alternate exemplary embodiments of a hydraulic control unit (HCU) having a controlled braking pump and a pre-charge pump driven by a single motor, for use in the EHCU of FIG. 4 and the controlled braking apparatus of FIG. 5;

FIGS. 8 and 9 are respectively a schematic of an exemplary embodiment of a controlled braking system according to our invention having a pair of controlled braking pumps and a pair of pre-charge pumps all driven by the same motor, and a perspective view of an EHCU, according to our invention, including the pair of controlled braking pumps and a pair of pre-charge pumps all driven by the same motor, together with other hydraulic components, in an HCU.

FIGS. 10-12 are respectively a schematic of an exemplary embodiment of a hybrid controlled braking system, according to our invention, a perspective view of an HCU for use in the braking system of FIG. 10, including a controlled braking pump and a pre-charge pump driven by a single motor, together with other hydraulic components, and a cross sectional view taken through the pumps of the HCU of FIG. 11; and

FIGS. 12-15 are schematic representations of alternate exemplary embodiments of braking systems incorporating an HCU or EHCU, according to our invention.

### DETAILED DESCRIPTION

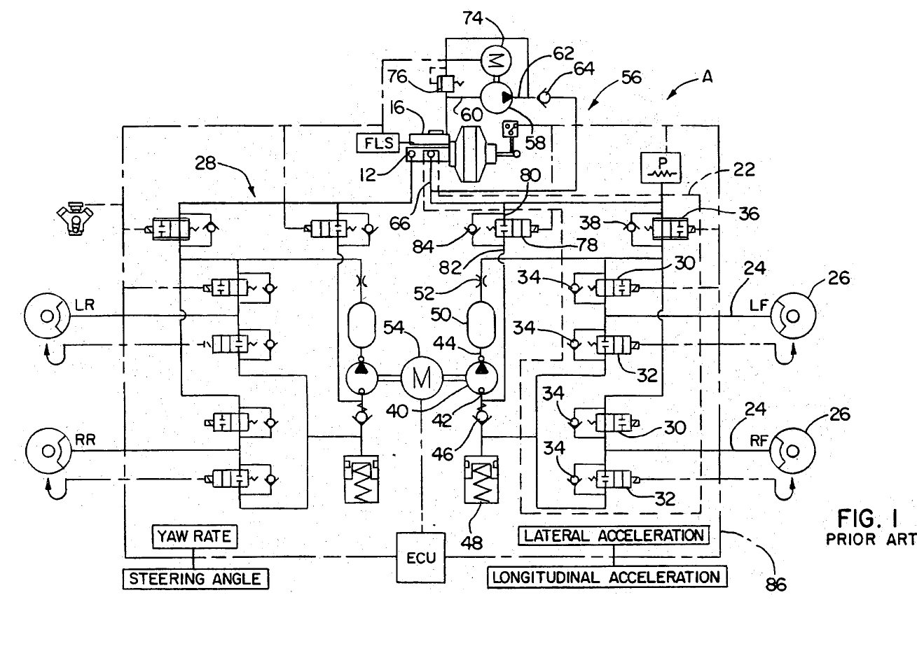

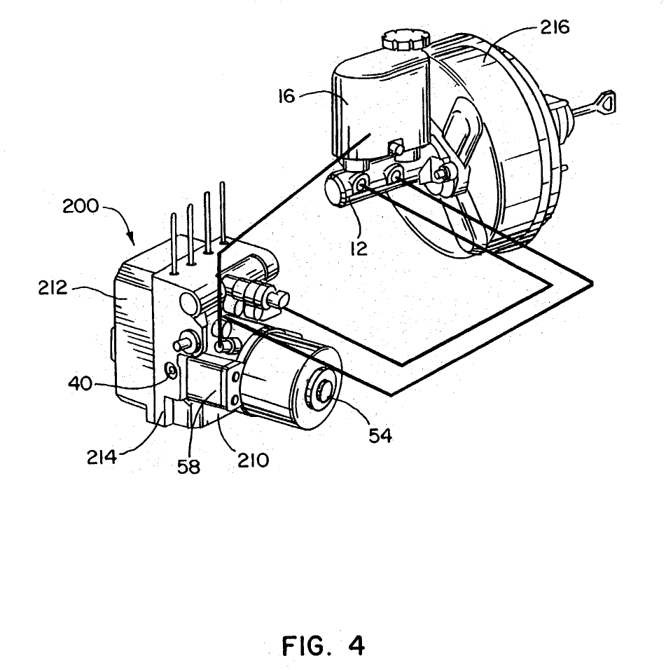

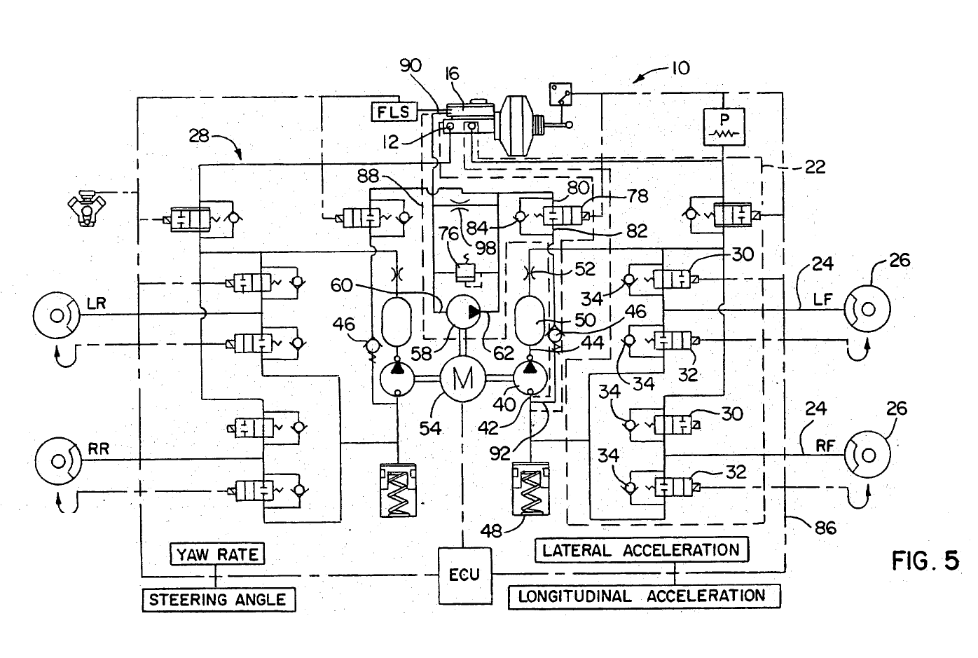

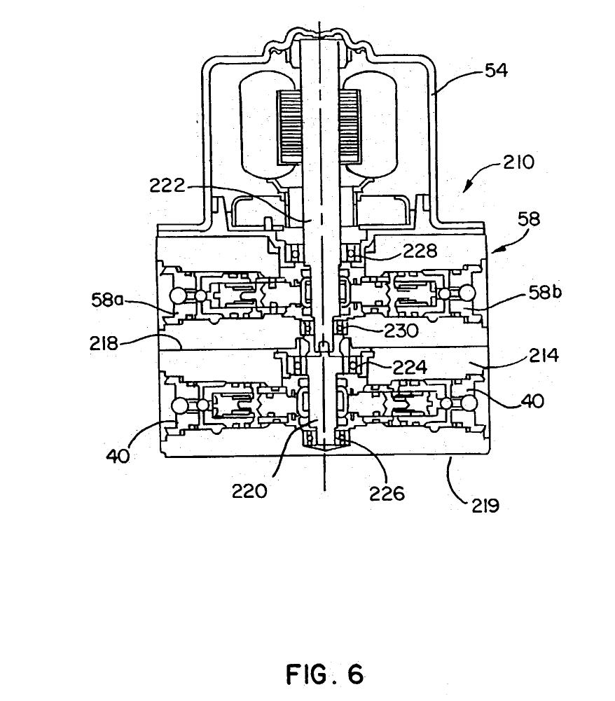

FIG. 5 shows a first exemplary form of a brake apparatus 10. FIG. 4 and FIG. 6 show components of the brake apparatus, including an EHCU 200, having an ECU 212 attached to an HCU 210, according to our invention. The embodiment depicted in FIGS. 4-6 includes many of the same components as the prior apparatus A discussed above with regard to FIGS. 1-3.

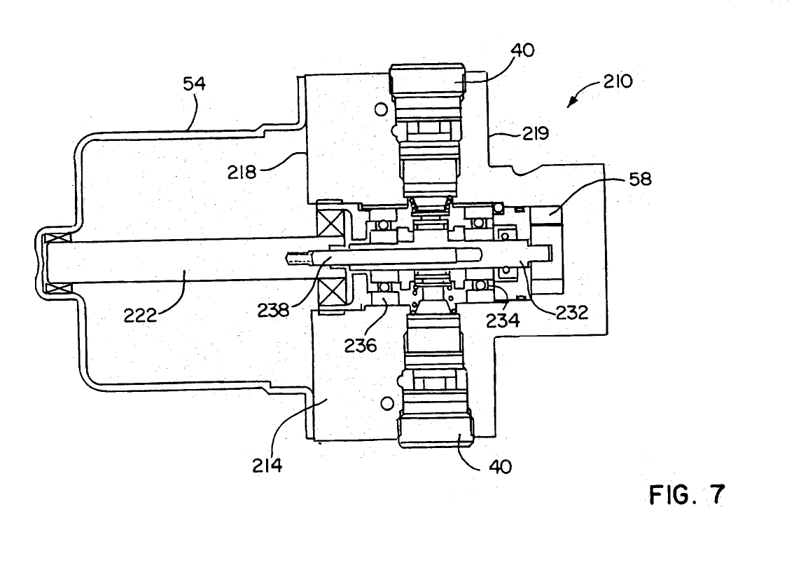

To facilitate understanding of our invention, and the distinctions between our invention and prior brake systems, the components in FIGS. 4-6 and subsequent FIGS. 7-15 that are substantially equivalent or similar to the components described above, in the Background of the Invention, will be given the same reference numbers used in the Background of the Invention. For the sake of brevity, where components bearing similar reference numbers are substantially equivalent or similar in function to the components described in detail above, the description of those components and their functions will not be repeated below. For the sake of clarity, the reference numerals for a particular component may be omitted in a subsequent drawing where that component has been identified in a previous drawing.

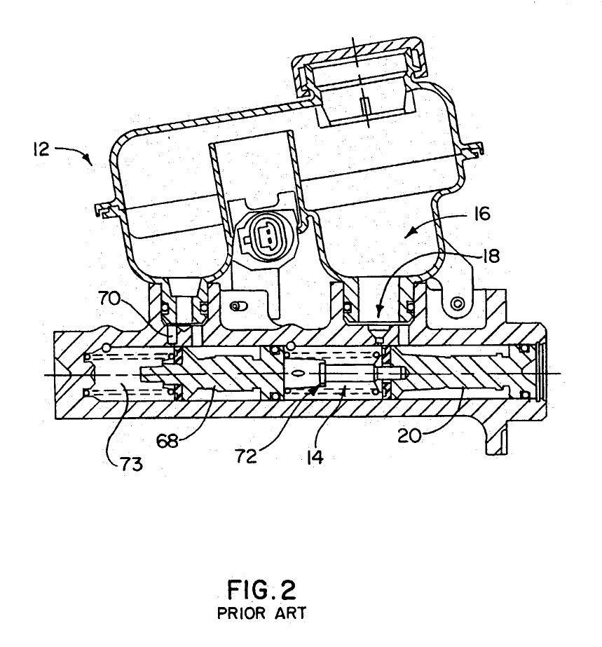

The exemplary embodiment of the brake apparatus 10 depicted in FIG. 5, includes a master cylinder 12 similar to the one depicted in FIG. 2, having a cylinder bore 14, a fluid reservoir 16 for brake fluid, a bleed port 18 providing fluid communication between the cylinder bore 14 and the fluid reservoir 16, and a primary piston 20 movable in the bore 14 for closing off the bleed port 18 and generating hydraulic braking pressure in the bore 14.

A primary hydraulic brake circuit 22, indicated by dashed lines, is connected in a series fluid circuit relationship to the bore 14 of the master cylinder 12 for exchanging pressurized brake fluid at the braking pressure with an inlet/outlet 24 of the hydraulically actuated braking devices 26. The hydraulically actuated braking devices take the form of front brakes on the front wheels of a vehicle.

The brake apparatus 10 also includes a secondary brake circuit, generally designated by reference numeral and arrow 28, connected in a series fluid circuit relationship to the bore 14 of the master cylinder 12 for delivering pressurized brake fluid at the braking pressure to the rear front brakes, and for receiving a return flow of brake fluid from the rear brakes. The primary and secondary brake circuits 22, 28 are substantially identical. Accordingly, for the sake of brevity the following description will generally be directed to the primary brake circuit 22.

In both the primary and secondary brake circuits 22, 28, a controlled braking pump 40 has an inlet 42 for receiving brake fluid from the hydraulic brake circuit 22 and an outlet 44 for providing pressurized brake fluid to the hydraulic brake circuit 22 at the braking pressure. A pre-charge circuit 88 including a single pre-charge pump 58 supplies fluid to the inlets 42 of the controlled braking pumps 40 in both the primary and secondary brake circuits 22, 28.

The pre-charge circuit 88 has an inlet 90 operatively connected to the fluid reservoir 16, and an outlet 92 operatively connected to the inlet 42 of the controlled braking pump 40 in each of the primary and secondary brake circuits 22, 28, to thereby form a pair of parallel circuits to the series circuit formed by the cylinder bore 14 and the hydraulic brake circuit 22 for providing a pre-charge flow of brake fluid to the inlets 42 of the controlled braking pumps 40 at a pre-charge pressure.

The pre-charge circuit 88 includes a back-flow check valve 46 near the inlet 42 of each controlled braking pump 40, for allowing the pre-charge flow of brake fluid to pass through the back-flow check valve 46 from the fluid reservoir 16 to the inlet 42 of the controlled braking pump 40 and blocking a flow of brake fluid from the inlet 42 of the controlled braking pump 42 to the fluid reservoir 16. The primary brake circuit 22 of the brake apparatus 19 further includes an accumulator 48 commonly connected in fluid communication with the inlet 42 of the controlled braking pump 40, the inlet/outlet 24 of the hydraulically actuated braking devices 26, and the outlet 92 of the pre-charge circuit 88. The connection to the inlet/outlet 24 of the hydraulically actuated braking devices 26 is provided via an outlet 27 of the primary braking circuit 22 flowing through the series-connected control valve 32. The secondary brake circuit 28 also includes a similar arrangement of hydraulic components including an accumulator 48, connected in similar fashion to the inlet/outlet of the rear brakes.

The pre-charge pump 58 has an inlet 60 operatively connected to the fluid reservoir 16, and an outlet 62 operatively connected to the inlets 42 of the controlled braking pumps 40. Specifically, the outlet 62 of the pre-charge pump 58 is connected in a series circuit relationship to the inlet 80 of a prime valve 78 in each of the primary and secondary brake circuits, and the outlet 82 of the prime valve 78 is connected in a series circuit relationship through the back-flow check valve 46 to the inlet 42 of the controlled braking pump 40 in that circuit, for selectively blocking or passing a flow of brake fluid through the prime valve 78 in that circuit.

Also in contrast to the prior brake apparatus A shown in FIG. 1, the brake apparatus 10 shown in FIG. 5 includes a single motor 54 operatively connected for driving the controlled braking pumps 40 in both the primary and secondary brake circuits 22, 28 and the pre-charge pump 58.

The pre-charge circuit 88 shown in FIG. 5 further includes a pressure operated relief valve 76 operatively connected from the outlet to the inlet of the pre-charge pump 58. A bleed orifice 98, of small diameter, on the order of 0.010 inch, is connected in parallel to the pressure operated relief valve 76 to facilitate bleeding air from the controlled braking system 10 to facilitate filling the braking system 10 with hydraulic brake fluid, utilizing the commonly practiced evacuation and filling techniques employed in many vehicle assembly plants.

The pre-charge circuit 88 further includes a check valve 84 operatively connected from the outlet 82 of the prime valve 78 to the outlet 62 of the pre-charge pump 58 for blocking flow through the check valve 84 from the inlet to the outlet 80, 82 of the prime valve 78, and allowing flow through the check valve 84 from the outlet 82 to the inlet 80 of the prime valve 78.

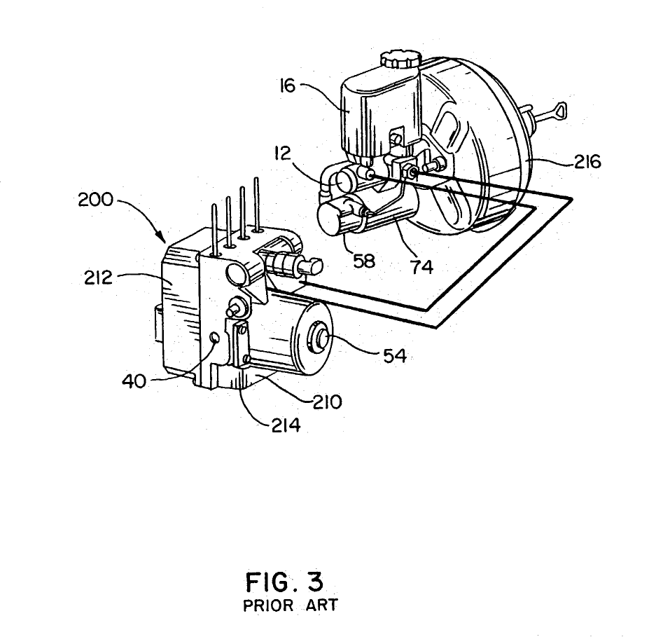

As shown in FIG. 4, the controlled braking pumps 40, and the pre-charge pump 58 are incorporated into a hydraulic control unit (HCU) 210 of an EHCU 200, and are driven by a single motor 54, thereby allowing the separate drive motor 74 used for driving the pre-charge pump 58 in the prior controlled braking system A, as shown in FIGS. 1 and 3, to be eliminated, so that no components of the pre-charge circuit need to be mounted remotely from the EHCU 200.

As shown in FIGS. 4 and 6 the HCU 210 in the first exemplary embodiment thereof includes a block 214. The controlled braking pumps 40 are mounted within the block 214, and the pre-charge pump 58 is mounted on an outside surface 218 of the block 214.

The HCU 210 includes a drive shaft apparatus operatively connected for driving both the pre-charge pump 58 mounted outside of the block 214 and the controlled braking pumps 40 mounted inside of the block 214. Specifically, in the embodiment of the HCU 210 shown in FIG. 6, the controlled braking pumps 40 are piston pumps driven by an eccentric of self-supported stub shaft 220, journaled by a pair of bearings 224, 226 in the block 214, and adapted for operative connection to a motor shaft 222 extending from the motor 54. The motor shaft 222 extends through the pre-charge pump 58 mounted on the outside surface 218 of the block 214 and engages the stub shaft 220 driving the controlled braking pumps 40 mounted inside of the block 214 for driving the controlled braking pumps 40. The motor-shaft 222 is journaled within the pre-charge pump 58 on a pair of bearings 228, 230.

In the embodiment of FIG. 6, the controlled braking pumps 40, and the pre-charge pump 58 are piston pumps driven by eccentrics on the stub shaft 220 and the motor shaft 22 respectively. The pre-charge pump 58 includes a pair of opposed pistons 58a, 58b, connected together by porting within the body of the pump 58 and/or the block 214 in a single stage parallel pumping arrangement, or alternatively in a two stage series pumping arrangement, for supplying fluid from a common outlet 62, shown in FIG. 5, of the pre-charge pump 58 to the controlled braking pumps 40 in both the primary and secondary circuits 22, 28.

It will be understood by those skilled in the art that either or both of the controlled braking pump 40, and a pre-charge pump 58 according to our invention may utilize other types of pumping mechanisms, such as gerotor pump, a gear pump, vane pump, etc. It will also be understood that the relative positions of the controlled braking pump 40, and the pre-charge pump 58 could be reversed in other embodiments, with pre-charge pump 58 being mounted within the block 214, and the controlled braking pump 40 being mounted on the outside surface 218 of the block 214. It will be further understood that the motor 54 may be mounted directly on the outer surface 218 of the HCU 210 and engage the stub shaft 222 for driving whichever pump 40, 58 is mounted inside of the block 214, and the other of the pumps 40, 58 may be mounted on a second outside surface 219 of the block 214 opposite the surface 218 to which the motor 54 is mounted, with the stub shaft 22 extending out of the block 214 through the second outside surface 219 of the block 214 for engaging and driving whichever pump 40, 58 is mounted on the second surface 119 of the block 214.

FIG. 7 shows an embodiment of an HCU 210 having a pair of controlled braking pumps 40, and a pre-charge pump 58 mounted within the block 214 and driven by a stub shaft 232, journaled within the block by a pair of bearings 234, 236. A quill shaft 238 operatively connects the stub shaft 232 to the shaft 222 of the motor 54, which is mounted on the outer surface 218 of the block 214. This embodiment provides several advantages over the embodiment shown in FIG. 6, in that the number of bearings 234, 236 is reduced from four to two, and there are fewer seals required. It will be noted that the pre-charge pump 58 in this configuration could also have been housed in a separate pump housing mounted on the second side 219 of the block 214. Furthermore, although the embodiment of FIG. 7 is shown with the controlled braking pumps 40 as eccentric driven piston pumps, and the pre-charge pump 58 as a gerotor pump, other types of pumping devices could be used for the pumps 40, 58 in other embodiments.

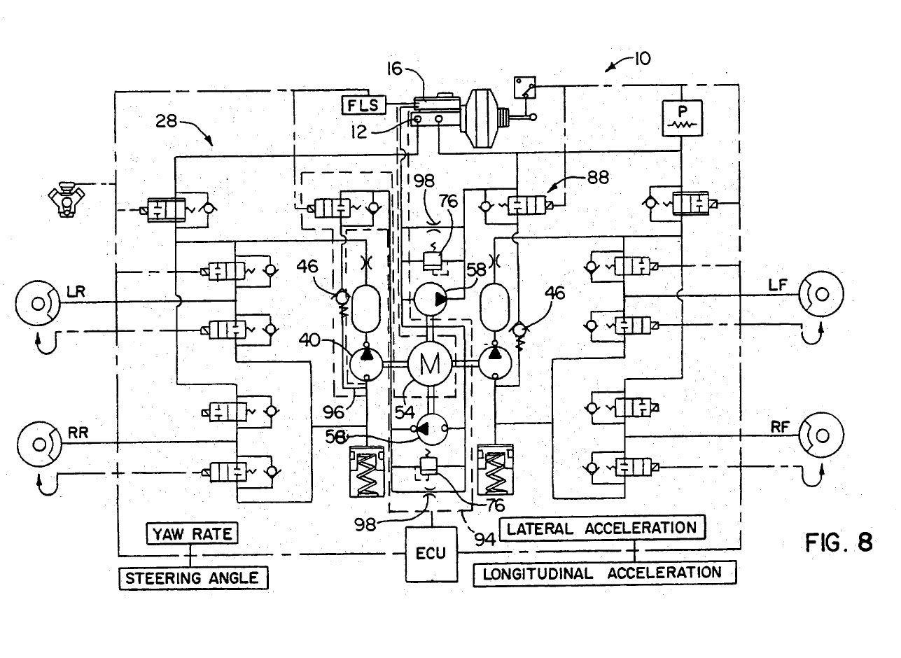

FIG. 8 shows an alternate exemplary embodiment of a brake apparatus 10, according to our invention, having a second pre-charge circuit 94 connected between the fluid reservoir 16 and the inlet 96 of the controlled braking pump 40 of the secondary hydraulic braking circuit 28, in-such a manner that the primary brake circuit 22 as shown in FIG. 5, and the secondary brake circuit 28 each have their own pre-charge circuits 88, 94. The second pre-charge circuit 94 is identical in all other respects to the pre-charge circuit 88 described above. The second pre-charge circuit also includes a second pre-charge pump 58 driven by the same motor 54 used for driving the controlled braking pumps 40 in the primary and secondary braking circuits 22, 28. An HCU 210, as shown in FIG. 6, having two pairs of opposed piston pumps, may be used in the brake apparatus 10 of FIG. 8. The pair of piston pumps 40 mounted within the block 214, can be connected individually to the primary and secondary brake circuits 22, 28, to function as controlled braking pumps 40, and a second pair of piston pumps 58 mounted on the outer surface 218 of the block 214, which may be connected individually to the first and second pre-charge circuits 88, 94, to function as the pre-charge pumps 58 for those circuits 88, 94.

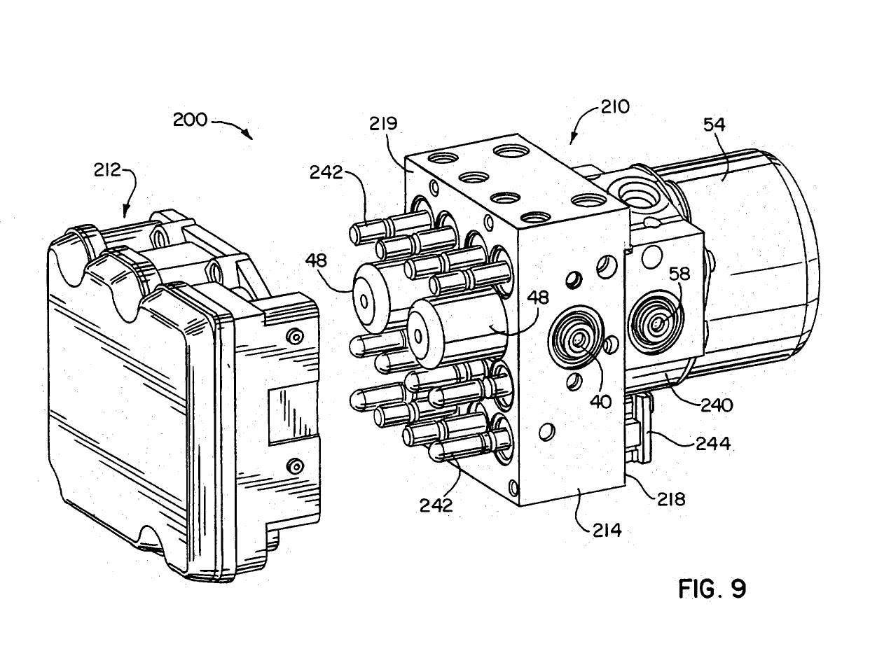

FIG. 9 shows an exemplary embodiment of an EHCU 200 that may be used with a braking apparatus 10, such as the one shown in FIG. 8, having a pair of controlled braking pumps 40 and a pair of pre-charge pumps 58, all driven by a single motor 54. The EHCU of FIG. 9 includes an HCU 210, having a first pair of opposed piston pumps 40 mounted within the block 214, and a second pair of opposed piston pumps 58 mounted in a pre-charge pump housing 240, attached to the outer surface 218 of the block 214, and driven by a single motor 54 in the manner shown in FIG. 6. Only the pump shown in the second pre-charge circuit 28 is labeled in FIG. 8.

The HCU 210 of FIG. 9 also includes a number of the hydraulic components shown in FIG. 5 and FIG. 8 for controlling the flow of fluid in the controlled braking apparatus 10. Mounted in the block 214 are a number of solenoid-operated valves, including four apply valves 30, four release valves 32, two prime valves 36, two isolation valves 78. The armatures 242 (only 2 of 12 of which are labeled in FIG. 9) for the solenoids that actuate these valves 30, 32, 36, 78 extend outward from the second surface 119 of the block 214 of the HCU 210. The two inlet accumulators 48 for the primary and secondary circuits 22, 28 also extend outward from the second surface 219 of the block 214. Inside of the block 210 are internal passages interconnecting the valves 30, 32, 36, 78, the accumulators 48 and many other hydraulic components housed within bores internal to the HCU 210, including relief valves, orifices, check valves, and dampers. The check valves 34, 38, 84 across the solenoid operated valves 30, 32, 36, 78 may either be stand alone devices, or be provided by one-way lip seals in the valves 30, 32, 36, 78 as is known in the art. Mounted on the outside surface 218 of the block 214 is a sensor package 244, connected through ports opening toward the outside surface 218 of the block 214 to the internal passages in the block 214.

An ECU 212 is mounted on the second face 219 of the block 214 of the HCU 210, to form the EHCU 200. The ECU includes 12 electrical coils (not shown), one surrounding the armature 242 of each solenoid actuated valve 30, 32, 36, 78. The coils are selectively actuated by control electronics within the ECU 212 for opening and closing the solenoid actuated valves 30, 32, 36, 78.

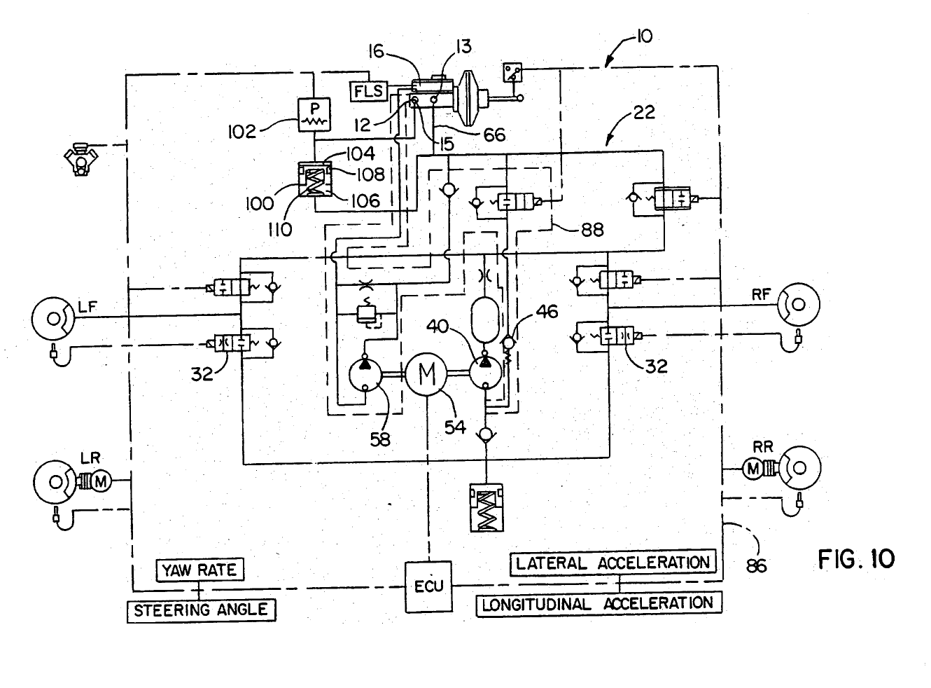

FIG. 10 shows a hybrid brake apparatus 10 according to our invention, having front hydraulic brakes LF, RF, and electrically actuated rear brakes LR, RR. The hybrid brake apparatus 10 includes a pre-charge circuit 88 as described above, with the motor 54 driving both the controlled braking pump 40 and the pre-charge pump 58. The secondary hydraulic circuit 28 includes a pedal-feel emulator 100 and a pressure sensor 102 operatively connected to receive pressurized brake fluid from the secondary piston 68 of the master cylinder 12.

As shown in FIG. 2, the master cylinder 12 in the exemplary embodiment of the brake system 10 shown in FIG. 9, includes a secondary piston 68 in the cylinder bore 14, separated from the first piston 20 to form a primary fluid cavity 72 in the bore 14 between the primary and secondary pistons 20, 68. The primary fluid cavity is connected in fluid communication through a primary port 13 of the master cylinder 12 to the hydraulic brake circuit 22. The master cylinder 12 also includes a secondary fluid cavity 73 between the second piston 68 and the bore 14, and connected to a secondary fluid port 15 of the master cylinder 12.

A brake pedal feel emulator 100, according to the present invention, has a first and a second fluid cavity 104, 106 on opposite sides of a movable wall 108. The first fluid cavity 104 of the pedal feel emulator 100 is connected in fluid communication to the secondary fluid cavity 73 of the master cylinder 12, through the secondary fluid port 15 of the master cylinder 12. The second fluid cavity 106 of the pedal feel emulator 100 is connected in fluid communication to the primary fluid cavity 72 of the master cylinder 12, through the primary fluid port 13 of the master cylinder 12. By virtue of adding the second fluid cavity 106 in the pedal feel emulator 100 of the present invention, connected in fluid communication with the primary fluid cavity 72 of the master cylinder 12, as shown in FIG. 5, the pressure existing in the primary cavity 72 of the master cylinder is applied directly to the back side of the movable wall 108, and indirectly to the front side (first fluid cavity 104) of the pedal feel emulator 100, to thereby provide a hydraulic lock against movement of the movable wall 108 of the pedal feel emulator 100 until hydraulic pressure is lost in the primary fluid cavity 72 of the master cylinder 12. Thus, when the primary circuit is functional, there are no additional travel losses occurring-from the pedal feel emulator 108.

Once pressure in the primary cavity 72 is lost, the pressure on the back side of the movable wall 108 of the pedal feel emulator 100 will drop to atmospheric pressure, and the primary piston 20 will move forward under pedal pressure to a lower pedal position, whereas the primary piston 20 will bear against the secondary piston 68. Further pedal movement will then move the secondary piston 68 in the bore 14 to expel fluid from the secondary fluid cavity 73 of the master cylinder 12 into the pedal feel emulator 100. A spring mechanism 110 in the pedal feel emulator 100 resists movement of the movable wall 108 of the pedal feel emulator 100, to simulate normal pedal feel to the operator, albeit at a lower pedal height than normal.

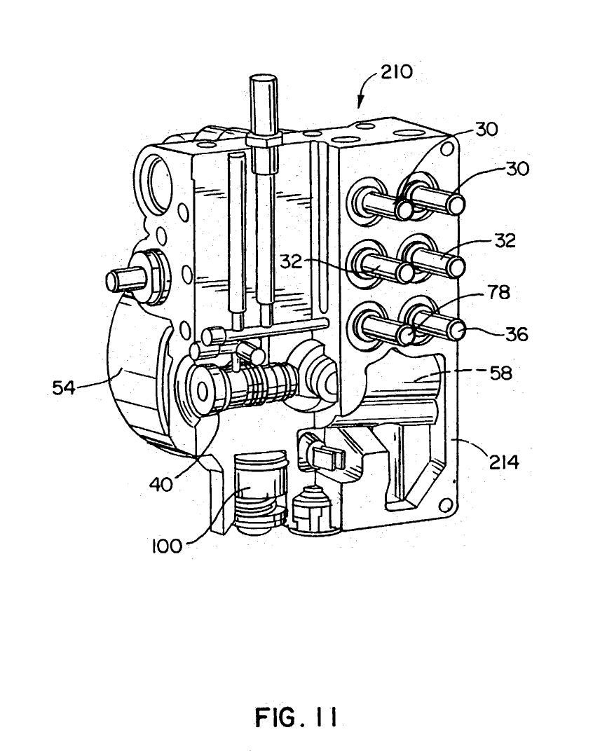

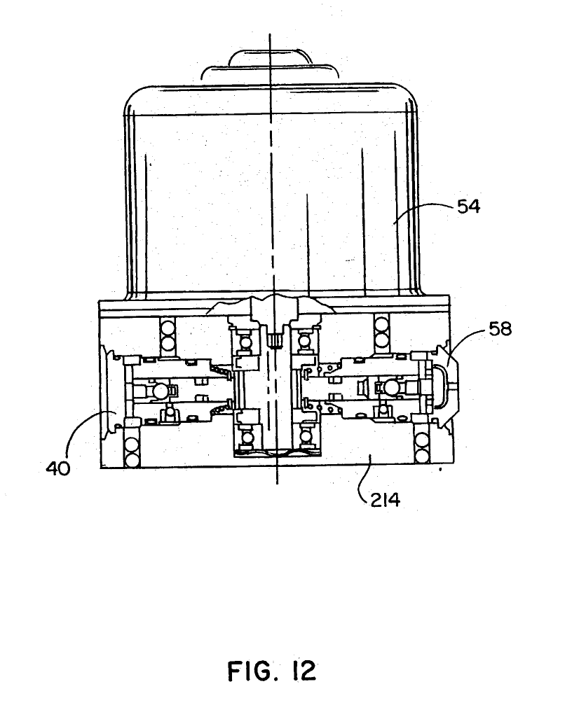

An HCU 210, as shown in FIGS. 11 and 12, may be used in the brake apparatus 10 of FIG. 10. The HCU 210 of FIGS. 11 and 12 includes a first and a second piston pump 40, 58 mounted within the block 214 and driven by a single motor 54, which may be connected individually, one to the primary brake circuits 22, to function as the controlled braking pump 40, and the other to the pre-charge circuit 88. The HCU 210 of FIG. 11 also includes a number of the hydraulic components shown in the system of FIG. 10, including two apply valves 30, two release valves 32, a prime valve 78, an isolation valve 36, and a pedal feel emulator 100.

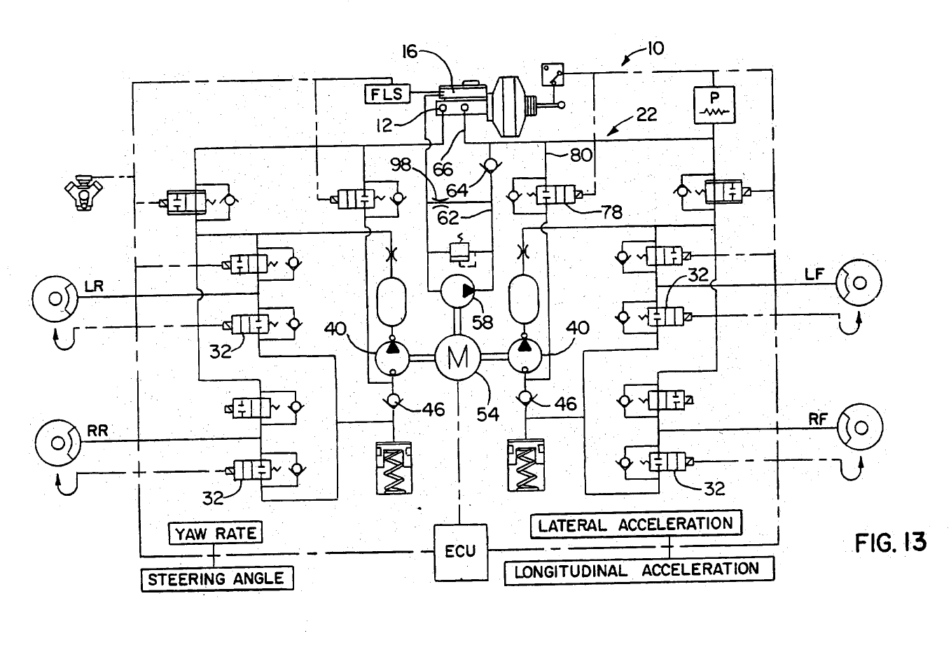

FIGS. 13-15 illustrate several more embodiments of controlled braking systems 10 in which the controlled braking pumps 40 and pre-charge pumps 58, driven by a single motor 54, together with hydraulic components for controlling the brake apparatus 10, can be combined into an HCU 210 or an EHCU 200, according to our invention, in the embodiments shown in FIGS. 4, 6, 7, 9, 11 or 12, or in other configurations not specifically disclosed herein but within our contemplation and the scope of the appended claims.

FIG. 13 shows an embodiment of a brake apparatus 10, according to our invention, having a pre-charge pump 58 driven by a common motor 54 with a pair of controlled braking pumps 40, in the same manner as described above with regard to the embodiment of FIG. 5, but having the outlet 62 of the pre-charge pump and the inlet 80 of a prime valve 78 connected to the inlet 66 of only the primary hydraulic brake circuit 22 and bore 14, as described above in relation to FIG. 1. An outlet check-valve 64 is located between pre-charge pump 58 and primary hydraulic brake circuit 22 to prevent reverse flow of fluid from the primary circuit 22 through the pre-charge pump 58 and pressure relief valve 76. An HCU 210 or an EHCU 200 as shown in FIGS. 4, and 6-7 can be used with the brake apparatus of FIG. 13.

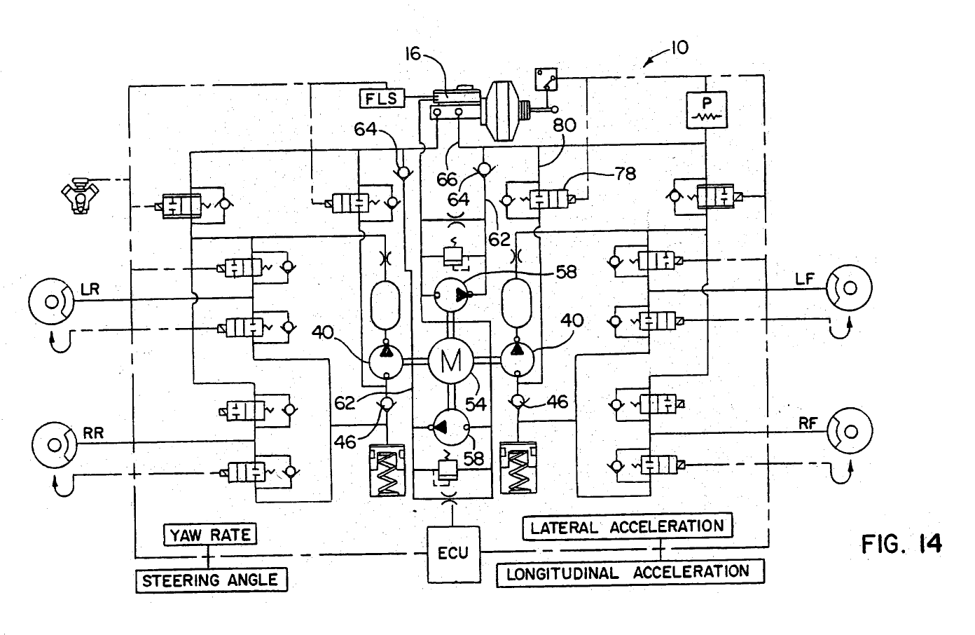

FIG. 14 shows an embodiment of our brake apparatus 10 that is similar to the embodiment in FIG. 8, but having a second pre-charge pump 58 and a second prime valve 78 connected in the same manner as the first pre-charge pump and prime valve 58, 78 described above with respect to FIG. 8, and both pre-charge pumps 58 being driven in common by motor 54 with two controlled braking pumps 40. An outlet check valve 64 is located between each pre-charge pump 58 and its respective hydraulic brake circuit 22, 28 to prevent reverse flow of fluid from either the primary or secondary circuit 22, 28 through the pre-charge pump 58 and pressure relief valve 76 serving that circuit 22, 28. An HCU 210 or an EHCU 200 as shown in FIGS. 8 and 9 can be used with the brake apparatus of FIG. 14.

Those having skill in the art will recognize that, while we presently consider it preferable to have the components according to our invention arranged as described above, we contemplate many other arrangements within the scope of our invention.

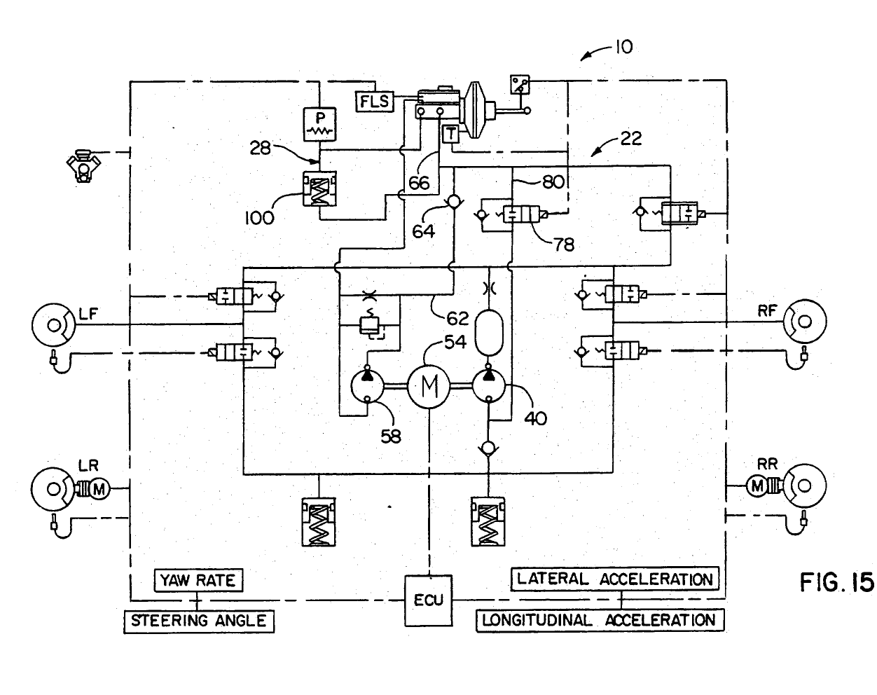

For example, FIG. 15 shows an embodiment of our invention in a hybrid brake system having the pre-charge circuit in series with the primary brake circuit, in a manner similar to the embodiment shown in FIG. 1, but having a pedal feel emulator 100 and an HCU 210, according to the present invention, as described above with regard to FIGS. 10-12. FIG. 15 shows a hybrid brake apparatus 10, according to our invention having a pre-charge pump 58 and a controlled braking pump 40 both driven by a common motor 54, as described above in relation to FIGS. 10-12, but having the output 62 of the pre-charge pump 58 and the inlet 80 of a prime valve 78 connected to the inlet 66 of the hydraulic brake circuit 22 and bore 14, as described above in relation to FIGS. 1 and 2.

Those skilled in the art will recognize that any embodiment of an HCU according to our invention may include one or more components for controlling the brake apparatus, in the same manner as is specifically disclosed for the HCU of FIG. 9 and FIG. 11.

We also contemplate that the hydraulic locking method and apparatus of our invention, as disclosed above with regard to the embodiments shown in FIGS. 10 and 15, may be utilized for locking a pedal feel emulator against movement until hydraulic pressure is lost in the primary brake circuit in all hydraulic or other types of brake systems that may or may not include a pre-charge circuit.

In summary therefore, while the embodiments of our invention disclosed herein are presently considered to be preferred, various changes and modifications can be made without departing from the spirit and scope of the invention. The scope of the invention is indicated in the appended claims, and all changes or modifications within the meaning and range of equivalents are intended to be embraced therein.

We claim:

1. A hydraulic control unit (HCU) for a brake apparatus, the HCU comprising:
a controlled braking pump;
a pre-charge pump; and
a motor operatively connected for driving both the controlled braking pump and the pre-charge pump.

2. The HCU of claim 1 wherein:
the controlled braking pump includes an inlet for receiving brake fluid from a hydraulic brake circuit and an outlet for providing pressurized brake fluid to the hydraulic brake circuit; and
the pre-charge pump has an inlet for receiving fluid from a fluid reservoir and an outlet operatively connected to the inlet of the controlled braking pump.

3. The HCU of claim 1 wherein:
the brake apparatus includes a brake circuit and a fluid reservoir;
the controlled braking pump includes an inlet for receiving brake fluid from the hydraulic brake circuit and an outlet for providing pressurized brake fluid to the hydraulic brake circuit; and
the pre-charge pump has an inlet operatively connected to the fluid reservoir and an outlet operatively connected to the inlet of the controlled braking pump.

4. The HCU of claim 1 wherein:
the brake apparatus includes a master cylinder having a cylinder bore, a fluid reservoir for brake fluid, a bleed port providing fluid communication between the cylinder bore and the fluid reservoir, and a primary piston movable in the bore for closing off the bleed port and generating hydraulic braking pressure in the bore, a hydraulic brake circuit connected in a series fluid circuit relationship to the bore of the master cylinder for delivering pressurized brake fluid at the braking pressure to an inlet of a hydraulically actuated braking device and receiving a return flow of brake fluid from an outlet of the hydraulically actuated braking device, a pre-charge circuit having an inlet operatively connected to the fluid reservoir and an outlet operatively connected to the inlet of the controlled braking pump to thereby form a parallel circuit to the series circuit formed by the cylinder bore and the hydraulic brake circuit for providing a pre-charge flow of brake fluid to the inlet of the controlled braking pump at a pre-charge pressure;
the controlled braking pump includes an inlet for receiving brake fluid from the hydraulic brake circuit and an outlet for providing pressurized brake fluid to the hydraulic brake circuit; and
the pre-charge pump has an inlet operatively connected to the fluid reservoir and an outlet operatively connected to the inlet of the controlled braking pump.

5. The HCU of claim 1, further including one or more hydraulic components for controlling a flow of hydraulic fluid in the braking apparatus.

6. The HCU of claim 5 further including a pedal feel emulator.

7. The HCU of claim 6 wherein the brake apparatus comprises a hydraulic brake circuit including a master cylinder having a first and a second piston in a bore, with the second piston in the bore separated from the first piston to form a primary fluid cavity in the bore between the first and second pistons connected in fluid communication to the hydraulic brake circuit and a secondary fluid cavity between the second piston and the bore; and
the brake pedal feel emulator comprises a first and a second fluid cavity on opposite sides of a movable wall, with the first fluid cavity of the pedal feel emulator connected in fluid communication to the secondary fluid cavity of the master cylinder, and the second fluid cavity of the pedal feel emulator connected in fluid communication to the primary fluid cavity of the master cylinder, to thereby provide a hydraulic lock against movement of the movable wall of the pedal feel emulator until hydraulic pressure is lost in the primary fluid cavity of the master cylinder.

8. The HCU of claim 1 further including a block, with at least one of the controlled braking pump or the pre-charge pump mounted within the block.

9. The HCU of claim 8 wherein both the controlled braking pump or the pre-charge pump are mounted within the block.

10. The HCU of claim 8 wherein the block includes an outer surface thereof and at least one of the controlled braking pump or the pre-charge pump is attached to an outer surface of the block.

11. The HCU of claim 10 further including a drive shaft operatively connected for driving both the pump mounted outside of the block and the pump mounted inside of the block, and adapted for operative connection to the motor.

12. The HCU of claim 11 wherein the motor is attached to the pump mounted on the outside surface of the block and engages the drive shaft, and the drive shaft extends into the pump mounted on the outside surface of the block for driving the pump mounted on the outside of the block.

13. The HCU of claim 12 wherein the drive shaft extends through the pump mounted on the outside of the block and into the pump mounted inside of the block for driving the pump mounted inside of the block.

14. The HCU of claim 11 wherein the motor is attached to the outside surface of the block and engages the drive shaft for driving the pump mounted inside of the block.

15. The HCU of claim 14 wherein the drive shaft extends through the block and engages the pump mounted on the outside surface of the block for driving the pump mounted on the outside of the block.

16. An electro-hydraulic control unit (EHCU) for a brake apparatus, the EHCU comprising:
a hydraulic control unit HCU including a controlled braking pump, a pre-charge pump, and a motor operatively connected for driving both the controlled braking pump and the pre-charge pump; and
an electronic control unit (ECU) for controlling the HCU attached to the HCU.

17. The EHCU of claim 16 wherein the HCU includes a block and at least one of the controlled braking pump or the pre-charge pump is mounted within the block.

18. The EHCU of claim 17 wherein the HCU includes one or more hydraulic components mounted within the block for controlling a flow of hydraulic fluid in the braking apparatus.

19. The EHCU of claim 18 wherein the ECU is attached to the block and controls one or more of the one or more hydraulic components mounted within the block.

20. A method for operating a hydraulic control unit (HCU) for a brake apparatus, where the HCU includes both a controlled braking pump and a pre-charge, the method comprising connecting a motor to both the controlled braking pump and the pre-charge pump for driving both the controlled braking pump and the pre-charge pump from the motor.
